(19) United States
(12) Patent Application Publication
(10) Pub. No.: US 2014/0281539 A1
(43) Pub. Date: Sep. 18, 2014

(54) Secure Mobile Framework With Operating System Integrity Checking

(71) Applicant: Goldman, Sachs & Co., New York, NY (US)

(72) Inventors: Daniel Faltyn, New York, NY (US); Andrew J.R. Smith, Purchase, NY (US)

(73) Assignee: Goldman, Sachs & Co., New York, NY (US)

(21) Appl. No.: 14/293,765

(22) Filed: Jun. 2, 2014

Related U.S. Application Data
(63) Continuation-in-part of application No. 13/854,837, filed on Apr. 1, 2013.
(60) Provisional application No. 61/618,511, filed on Mar. 30, 2012.
(60) Provisional application No. 61/806,763, filed on Mar. 29, 2013.

(51) Int. Cl. H04L 29/06; H04L 9/08

(52) U.S. Cl. CPC H04L 63/08; H04L 9/0861; H04L 9/0863
USPC 713/168; 726/9

(57) ABSTRACT

Systems and methods for a secure mobile framework to securely connect applications running on mobile devices to services within an enterprise are provided. Various embodiments provide mechanisms of securitizing data and communication between mobile devices and end point services accessed from a gateway of responsible authorization, authentication, anomaly detection, fraud detection, and policy management. Some embodiments provide for the integration of server and client-side security mechanisms, and for the binding of a user/application/device to an endpoint service along with multiple encryption mechanisms. For example, the secure mobile framework provides a secure container on the mobile device, secure files, a virtual file system partition, a multiple level authentication approach (e.g., to access a secure container on the mobile device and to access enterprise services), and a server side fraud detection system. In some embodiments, the multiple level authentication approach can include an operating system integrity check as part of the secure mobile framework.

### CROSS-REFERENCE TO RELATED APPLICATIONS

This application is a continuation-in-part of Ser. No. 13/854,837, filed Apr. 1, 2013 entitled “Secure Mobile Framework” which claims priority to U.S. Provisional Application Ser. No. 61/618,511 filed Mar. 30, 2012 and U.S. Provisional Application Ser. No. 61/806,763 filed Mar. 29, 2013, the entire contents of each are incorporated herein by reference for all purposes.

### TECHNICAL FIELD

Various embodiments of the present invention generally relate to mobile devices. More specifically, some embodiments of the present invention relate to a secure mobile framework for securely connecting applications running on mobile devices to services within an enterprise.

### BACKGROUND

Many companies or enterprises are either providing mobile devices (e.g., smartphones, tablets, etc.) to employees or allowing employees to bring their own mobile device. However, allowing employees to access services within the company through a mobile device has increased the company's exposure to potential security breaches. For example, if an employee lost their mobile device, an unauthorized party could retrieve any unsecured data on the phone and potentially access services within the company. As another example, if the employee leaves the company and does not give back the mobile device, the former employee could still potentially access sensitive data stored on the device or within the company.

In order to mitigate this type of unauthorized access, many companies use mobile device management (MDM) policies to restrict control of the mobile devices and thereby reduce potential security risks for mobile devices that are capable of connecting to services within the enterprise. The MDM policies that are set by the enterprise control and protect data through management of the configuration settings of the mobile devices. In order to manage the configuration settings, over-the-air programming (OTA) capabilities are often used. The use of OTA capabilities allows the enterprise to remotely configure a single mobile device or an entire fleet of mobile devices, to send software and operating system (OS) updates, and to remotely lock and wipe a device in order to protect the data stored on the device when it is lost or stolen, etc.

However, the restrictions imposed by the MDM polices can be cumbersome to the user who may also be using the device in a personal capacity. For example, an MDM policy may require the mobile device to auto lock and prompt the user to provide a password with a particular set of characteristics before the mobile device is unlocked. The user may find these restrictions annoying. As such, there are a number of challenges and inefficiencies created in traditional mobile device management.

### SUMMARY

Systems and methods are described for a secure mobile framework capable of securely connecting applications running on mobile devices to services (e.g., an e-mail service, a trading service, or a reservation service) within an enterprise. In some embodiments, an authentication request from a remote device to access a service provided by an enterprise can be received at a gateway associated with the enterprise. The request can originate from an enterprise-managed application running on the remote device. A framework authentication token and security policy (e.g., password structure, password duration, access controls for an application and/or secure container of data, etc.) can be generated.

The security policy can be based on the service provided by the enterprise that the remote device is requesting to access. The framework authentication token and the security policy can then be transmitted to the remote device which ensures compliance with the security policy before generating a connection request to connect to the service within the enterprise. The connection request can be based on the framework authentication token and the security policy. A service authenticator determines if the application running on the remote device is authorized to access the service. Some embodiments monitor interactions between the enterprise-managed application and the service. Upon detecting a violation of one or more fraud policies at the mobile device and/or gateway, an elevated authentication request can be generated.

In some embodiments, a request can be received from an initiating device to establish a service connection between an enterprise-managed application running on the initiating device and an enterprise service. The request includes authentication credentials associated with an end-user. A framework authentication token can be generated and transmitted to the initiating device, wherein upon receipt the initiating device initiates a service connection request based on the authentication token. A secure connection can be created between the enterprise service and the initiating device upon successful validation (e.g., authorization and authentication) of the service connection request. Any data transmitted to the initiating device using the stored connection can be stored within a secure container that is only accessible by the enterprise-managed application.

One of the immediate objectives of any hacker is to obtain application content and/or alter the binary to satisfy their own requirements. The later situation, which presents a more significant threat, enables the hacker to launch attacks using the legitimate user credentials if they can compromise the device in an undetected fashion. As such, the authentication framework, in accordance with various embodiments, may validate, or at least require that, the operating system integrity and/or the enterprise-managed application integrity be determined if a connection can be established between the enterprise-managed application and the service.

One of the overall objectives of evaluating the operating system integrity (e.g., jailbreak detection or rooting) is to evaluate the integrity of execution environment by testing various aspects of the sandbox. The sandbox is a set of restrictive policies and mechanisms which the operating system uses to enforce a particular scope of operation on the application. Thus, various embodiments have the application test known limits. If these known limits can be passed, then the device appears to have a compromised operating system integrity (e.g., jail broken or rooted). However, the hacker may suspect there are protections in the code. Thus, some embodiments are designed to force or lead the hacker down an avenue of analysis and patching that requires all checks to be discovered and removed. Various embodiments also add safeguards and countermeasures to make the cost of getting the analysis wrong and expensive by destroying usable information as quickly as possible. In some embodiments, the code path can be changed to yield different results or ultimately deny access to the enterprise.

Some embodiments not only check the OS integrity, but also check the executing application's integrity. This is certainly one form of defense against the broken operating system which looks intact however allows a re-crafted and malicious binary to operate. There are some inherent limitations to guaranteeing operating system integrity by the very nature of where the checks are being performed. If a compromised (e.g., jail broken or rooted) operating system looks perfectly intact from the applications perspective, then the application will operate under that assumption. Alternatively, if the hacker completely analyzes the binary and removes all integrity checks perfectly the first time such that it executes as if there were no checks engineered into it then equally it would act as normal. In both of these situations, additional defenses may be found in a DMZ and anomaly detection system which monitor the use of the applications activity to differentiate between legitimate and illegitimate users.

Embodiments of the present invention also include computer-readable storage media containing sets of instructions to cause one or more processors to perform the methods, variations of the methods, and other operations described herein.

In various embodiments, a system can include a gateway, an authenticator, a token generator, a communications module, a discovery service, and/or a fraud detection module. The gateway can be configured to provide remote devices access to services of an enterprise. In some embodiments, the gateway can include multiple levels, each of which provides isolated authentication protocols and activity logging. The remote devices can have stored thereon one or more applications managed by the enterprise. The authenticator can be configured to determine if a user is authorized to access the enterprise and to construct policies regarding the management of the one or more applications.

The token generator can be configured to generate one or more tokens (e.g., authentication token, a user binding token, and/or a framework authentication token) for creating secure connections between one or more applications managed by the enterprise and servers. The tokens can be based on various identifiers such as, but not limited to the following: user identifiers, device identifiers, device type identifiers, application family identifiers, etc. Some tokens may include a binding of other tokens. For example, in one embodiment, a framework authentication token can be based on an enterprise authentication token, a user binding token, and/or a framework authentication token expiration date. In some embodiments, one or more of the tokens may be cryptographically secured (e.g., digitally signed) that allow for the system to detect if the tokens have been tampered with or altered.

The communications module can be configured to communicate the policies to the remote devices. The discovery service can be configured to determine which of the services of the enterprise to connect with the one or more applications. The anomaly detector can be configured to monitor activity between the remote devices and the servers and generate an indicator of anomalies in activity. For example, the anomaly detector may monitor the IP velocity of the user, failed log-in attempts, etc.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 illustrates an example of a network-based environment in which some embodiments of the present invention may be utilized;

FIG. 2 is a flowchart with a set of exemplary operations for creating a binding between an enterprise-managed application and an enterprise service in accordance with one or more embodiments of the present invention;

FIG. 3 illustrates a set of components within a user device according to one or more embodiments of the present invention;

FIG. 4 illustrates a general architecture for a secure framework which can be used in accordance with various embodiments of the present invention;

FIG. 5 is a flowchart illustrating a set of exemplary operations for authorizing an enterprise-managed application in accordance with some embodiments of the present invention;

FIG. 6 is a flowchart illustrating a set of exemplary operations for creating a secure channel between an enterprise service and an enterprise-managed application running on a remote device in accordance with one or more embodiments of the present invention;

FIG. 7 is an example of an application built on a secure mobile framework which can be used with various embodiments of the present invention;

FIG. 8 illustrates a remote device accessing a service within an enterprise in accordance with some embodiments of the present invention;

FIG. 9 is a sequence diagram illustrating an initial authentication flow between a device application and an enterprise in accordance with one or more embodiments of the present invention;

FIG. 10 is a sequence diagram illustrating a continuous authentication flow between a device application and an enterprise in accordance with various embodiments of the present invention;

FIG. 11 illustrates a multi-stage key generation process based on multiple OS integrity checks in accordance with one or more embodiments of the present invention;

FIG. 12 illustrates an example of an ephemeral key generation in accordance with some embodiments of the present invention;

FIG. 13 illustrates an application integrity check in accordance with various embodiments of the present invention; and

FIG. 14 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention relate generally to a secure mobile framework capable of securely connecting applications running on mobile devices to services within an enterprise. Some examples of services provided by an enterprise include, but are not limited to, an e-mail service, a trading service, a payment processing service, a customer relationship management service, an inventory system service, a business intelligence service, a healthcare service, a student information service, a reservation service, secure services, and/or other services containing sensitive information. In accordance with some embodiments, the secure mobile framework provides a collection of software libraries and service components which provide software developers the ability to build secure applications on non-enterprise mobile devices. The secure mobile framework can be used in conjunction by enterprises that have firewalled content, services, and network from the public network through means of a DMZ-type architecture. As a result, much of the enterprise's existing authentication and authorization systems can be utilized. Client and server libraries can be utilized or extended to provide secure storage and communication in both the client and server applications.

There are a number of enterprises which through internal policy or regulation need to ensure that enterprise content and communication is protected, managed and monitored. Normally for devices managed by the enterprise, the aforementioned control requirements are directly implemented through device and operating system (OS) management. However, for devices which are not managed by the enterprise and cannot connect directly to the enterprise network, there is a need to ensure that the same controls are applied to enterprise applications running on these unmanaged devices.

In accordance with various embodiments, the secure mobile framework can provide one or more of the following features to connect and utilize services within the enterprise: 1) mechanisms to store enterprise content on a device in a protected manner whereby the enterprise content can only be accessed by authorized users, possibly offline, and be managed through enterprise policy; 2) mechanisms to provide multiple authentications against the gateway (i.e., framework authentication) and against the enterprise services (i.e., enterprise authentication), provide secure connection to those enterprise services where authorized, and manage per service access through enterprise policy; 3) mechanism to manage and support connected applications and their dependent services; and 4) mechanisms to dynamically detect an undesirable or unsafe operating system environment and manage through a multi-step process (e.g., evaluating the policy, interrogation of the program, interrogation of the OS, and/or performing other checks in the client and/or server environments).

The gateway can generate one or more tokens which can be used for authentication. For example, in some embodiments, an enterprise authentication token (EAT) can be generated representing a single or multi-factor credentials that can be used to authenticate with a given company as if single or multi factor credentials were presented, for a finite period of time. A user binding token (UBT) can also be used in one or more embodiments. The UBT can be an amalgamated, unique representation of a user (id), device (id), type of device, and app family. In addition, a framework authentication token (FAT) can be used in various embodiments. The FAT can be created by binding an EAT, UBT, and an expiration date used to authenticate with the framework. One advantage of this construction of the FAT is that the details cannot be tampered with by an unauthorized party.

In some embodiments, secure mobile framework client and server components can be used to detect the integrity of the operational environment for the client application. Given that the client application is executed within an unmanaged operating system environment, the client application may need to ascertain, as best it can, if the environment is considered to be unsafe. Common examples of unsafe operating system environments are devices on which the operating system restrictions that have been imposed by the OS manufacturer have been removed. This is commonly referred to as jailbreaking or rooting. In the case of Apple's iOS, for example, this process usually means removing various components of the code signing verification system and file access imposed by Seatbelt.

The operating system provides the security bedrock for many embodiments of the secure mobile framework by providing secure boot chain, signature enforced executables and sandboxed applications. A broken operating system cannot be trusted as it is possible that the broken operating system could be running malicious code performing anything from data leakage to a platform for advance persistent threat attacks (APT). Because the process of comprising operating system restrictions (e.g., jailbreaking an iOS device or rooting an Android device) is relatively easy it is quite possible that many of the devices will be broken for “legitimate” reasons.

However, even an operating system broken for a “legitimate” reason still breaks the security model and opens doors for hackers. In fact, if steps are not taken to close some obvious holes, like changing the root password, the ability of a hacker to gain control of the device becomes extremely trivial. As a result, the client applications in various embodiments perform the necessary checks to verify and establish if the original integrity of the operating system has been compromised. Certainly with iOS these checks have to be done by the application itself as there are no extraneous methods available due to the nature of the devices configuration and Apple restrictions. As such, various embodiments provide a multi-point check of the operating system through the application before allowing the remote device to connect to the gateway services.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

While, for convenience, embodiments of the present invention are described with reference to dedicated enterprise-based setups, embodiments of the present invention are equally applicable to various other operational models such as cloud-based models. In addition, while some of the following discussion focuses on iOS, many of the ideas readily translate to Android and other mobile operating systems. Moreover, the techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), application-specific integrated circuits (ASICs), magnetic or optical cards, flash memory, or other type of media/machine-readable medium suitable for storing electronic instructions.

### TERMINOLOGY

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices (e.g., mobile devices, server machines, etc.) may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” and the like generally mean the particular feature, structure, or characteristic following the phrase is included in at least one implementation of the present invention, and may be included in more than one implementation. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “module” refers broadly to a software, hardware, firmware, or service (or any combination thereof) component. Modules are typically functional components that can generate useful data or other output using specified input(s). A module may or may not be self-contained. An application program (also called an “application”) may include one or more modules, or a module can include one or more application programs.

### GENERAL DESCRIPTION

FIG. 1 illustrates an example of a network-based environment 100 in which some embodiments of the present invention may be utilized. As illustrated in FIG. 1, various enterprise-managed applications 110A-110N can be running on user devices 120A-120N. In accordance with various embodiments of the present invention, user devices 120A-120N may or may not be managed by the enterprise. User devices 120A-120N can include enterprise-managed applications 110A-110N that can be used to access services and data within the enterprise. User devices 120A-120N may use network 140 to submit and retrieve information from services within the enterprise. User devices 120A-120N can interact with various enterprise services through an application programming interface (API) that runs on the native operating system of the device, such as IOS® or ANDROID™.

Gateway 130 manages the access of enterprise-managed applications 110A-110N and user devices 120A-120N. Gateway 130 can be used to verify and establish a trust relationship between the enterprise-managed applications 110A-110N and business-specific services provided by the enterprise. For example, in some embodiments, the data and requests initially submitted by enterprise-managed applications 110A-110N are transferred between the device and gateway 130 via network 140. Once gateway 130 is satisfied with the security of the device, then gateway 130 can open up a channel to some business-specific service within the application management platform 150 and enterprise services 160. Gateway 130 and services within the application management platform 150 can have multiple independent layers of security and checks.

User devices 120A-120N can be any computing device capable of receiving user input as well as transmitting and/or receiving data via the network 140. In one embodiment, user devices 120A-120N can be any device having computer functionality, such as a personal digital assistant (PDA), mobile telephone, smartphone, tablet, wearable types of mobile computers, body-mounted computers, or similar device. User devices 120A-120N can be configured to communicate via network 140, which may comprise any combination of local area and/or wide area networks, using wired and/or wireless communication systems. In one embodiment, network 140 uses standard communications technologies and/or protocols. Thus, network 140 may include links using technologies such as Ethernet, 802.11, worldwide interoperability for microwave access (WiMAX), 3G, 4G, CDMA, digital subscriber line (DSL), etc.

Similarly, the networking protocols used within the various layers of network 140 may include multiprotocol label switching (MPLS), transmission control protocol/Internet protocol (TCP/IP), User Datagram Protocol (UDP), hypertext transport protocol (HTTP), hypertext transport protocol secure (HTTPs), simple mail transfer protocol (SMTP), file transfer protocol (FTP), secure file transfer protocol (SFTP), and/or other networking protocols. Data exchanged over network 140 may be represented using technologies and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

FIG. 2 is a flowchart with a set of exemplary operations 200 for creating a binding between an enterprise-managed application and an enterprise service in accordance with one or more embodiments of the present invention. As illustrated in FIG. 2, installation operation 210 installs an enterprise controlled application on a remote device. The application may be installed by an end-user of the device, an individual from the enterprise, or other source. For example, in some embodiments, the application may be remotely installed or downloaded from an application store. Once the application is installed, authentication operation 220 can prompt a user of the remote device to provide a set of credentials which can be authenticated against the framework. A variety of security protocols and standards (e.g., passwords, passcodes, time-based tokens, encrypted data, auto-lock, etc.) may be used as part of the remote device and application security and authentication processes.

A variety of authentication and security checks can be performed at the enterprise during authentication operation 230. In some embodiments, for example, once the set of credentials are received from the user, an authorization request can be sent from the remote device (i.e., the client) to the gateway server. The gateway server can determine a current policy which should be applied at the remote device and send policy information from the gateway server to the remote device. Then, the device characteristics can be checked and new container credentials can be acquired if necessary. If the gateway determines that the application should have access to one or more servers within the enterprise, creation operation 240 can be used to create a binding between the application and an enterprise service.

Various embodiments of the present invention provide systems and methods for checking the operating system integrity as part of authentication operation 230. These checks may be performed at the user device and/or at the enterprise. A broken operating system cannot be trusted as it is possible that the mobile device could be running malicious code performing anything from data leakage to a platform for advanced persistent threat attacks (APT). Because the process of jailbreaking an iOS device is relatively easy, it is quite possible that many of the devices will be broken for “legitimate” reasons. This still breaks the security model and opens doors for hackers. In fact, if steps are not taken to close some obvious holes, like changing the root password, the ability of a hacker to gain control of the device becomes extremely trivial. Various embodiments allow an enterprise gateway to use the operating integrity check in conjunction with other mobile application management techniques to determine if any violations are discovered. Access to enterprise services can be denied or immediately suspended if any violations are discovered.

FIG. 3 illustrates a set of components of a user device 120 according to one or more embodiments of the present invention. According to the embodiments shown in FIG. 3, user device 120 can include memory 305, one or more application processors 310, baseband processors 315, power supply 320, operating system 325, application 330, secure container 335, validator 340, key generator 345, encryption/decryption module 350, access module 355, data removal module 360, information module 365, policy manager 370, communications module 375, and graphical user interface (GUI) generation module 380. Other embodiments of the present invention may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, validator 340, key generator 345, and encryption/decryption module 350 can be combined into a single module for handling processing various encryption and decryption requests.

Memory 305 can be any device, mechanism, or populated data structure used for storing information. In accordance with some embodiments of the present invention, memory 305 can encompass any type of, but is not limited to, volatile memory, nonvolatile memory, and dynamic memory. For example, memory 305 can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, memory 305 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 305

Memory 305 may be used to store instructions for running one or more applications or modules on application processor(s) 310. For example, memory 305 could be used in one or more embodiments to house all or some of the instructions needed to execute the functionality of operating system 325, application 330, secure container 335, validator 340, key generator 345, encryption/decryption module 350, access module 355, data removal module 360, information module 365, policy manager 370, communications module 375, and/or GUI generation module 380.

Application processor(s) (AP) 310 are the main processors of user device 120. Application processor(s) provide the processing power to support software applications, memory management, graphics processing, and multimedia. AP 310 is communicably coupled with memory 305 and configured to run the operating system 325, the user interface, and the applications 330 stored on memory 305. Baseband processor 315 is configured to perform signal processing and implement/manage real-time radio transmission operations of user device 120. These processors along with the other components may be powered by power supply 320 (e.g., a battery or other power source).

Operating system 325 provides a software package that is capable of managing the resources (e.g., hardware resource) of user device 120. Operating system 325 can also provide common services for software applications running on AP 310. In accordance with various embodiments of the present invention, operating system 325 may act as an intermediary between applications 330 and hardware components. Applications 330 may include can include enterprise-managed applications 110A-110N that can be used to access services and data within the enterprise.

User device 120 may also include secure container 335 that allows for information to be securely stored. Secure container 335 may include one or more tokens or access keys that can be used to create a secure connection or validate a current state of user device 120. In some embodiments, secure container 335 can securely store information about an uncompromised operating system 325, information about an uncompromised application, and/or other information that may be sensitive.

In accordance with one or more embodiments, secure container 335 may be encrypted/decrypted using information about operating system 325. Secure container 335 may have multiple storage compartments that each contain different information. The encryption/decryption process may use a multi-level or multi-stage key generation sequence. For example, validator 340 can be used to test the operating system integrity and/or the application integrity at multiple points. Key generator 345 can then generate a key to access secure container 335 by performing a multi-level or multi-stage key generation sequence. The key generation sequence may be based on the operating system integrity and/or the application integrity determined by validator 340.

If the current state of operating system 325 and/or the application does not match the state of the operating system 325 used to encrypt secure container 335, then encryption/decryption module 350 will generate a different key than the access key needed to access secure container 335. The key generated by encryption/decryption module 350 can then be passed to access module 355. Access module 355 is configured to allow access to the secure container within the memory of the remote device. If the key generated by encryption/decryption module 350 does not successfully decrypt the content, data removal module 360 can remove data stored in the secure container. In some embodiments, when validator 340 determines that the operating system integrity has been compromised, an immediate request to remove the data may be sent to data removal module 360 and/or a notification may be sent to the enterprise.

Other types of inputs may also be part of the key generation sequence. For example, information from a remote service or gateway may be used. As another example, user-provided inputs (e.g., passwords) may be used in the key generation sequence. Information module 365 can be used to collect this information. In some cases, various information about the current policy being enforced by policy manager 370 may also be used as part of the key generation sequence.

Communications module 375 may be configured to manage and translate any requests or messages between components of user device 120, graphical user interface screens, remote service, networks, and/or any other component into a format required by the destination component and/or system. Similarly, communications module 375 may be used to communicate between systems and/or modules that use different communication protocols, data formats, or messaging routines. According to some embodiments, system components can communicate through messaging methods including extensible markup language (XML), proprietary message formats, and/or others.

GUI generation module 380 can generate one or more GUI screens that allow for interaction with user device 120. In at least one embodiment, GUI generation module 380 generates a graphical user interface allowing a user of the mobile device to set preferences, present reports, set device constraints, and/or otherwise receive or convey information to the user.

FIG. 4 illustrates a general architecture 400 for a secure mobile framework in accordance with various embodiments of the present invention. The secure mobile framework components can be used to manage and protect enterprise content stored on mobile device 405. In some embodiments, mobile device 405 can include a secure storage 410, policy 420, and/or authentication store 425 for mobile application 415. Mobile application 415 can have a virtual file system that sits under the application. In some embodiments, mobile application 415 can use or generate one or more ephemeral keys, which can have multiple constituent components. The ephemeral keys can be assigned to each partition of the virtual file system to encrypt every file with its own key.

Secure storage 410 can securely store enterprise data locally on mobile device 405. Secure storage 410 can include a group of protected files managed as a single unit through policy 420. In some embodiments, enterprise content can be stored in encrypted files and accessed via random access methods. In addition, various mechanisms can be used to set encryption block sizes on a per file basis and simultaneously maintain a sidecar index file used to aid with the synchronization content between client and service. The protected files are held within a secure partition which uses a single encrypted master file to hold per file encryption keys and a translation between applications file names and obfuscate file names. This secure file partition mechanism can be used to securitize not only application content directly but also used as a virtual file system for database servers hosted on the device, logging and telemetry data for customer support.

Policy 420 can be an application-specific (or application family) security policy set by the enterprise with which application 415 should comply. An application family generally refers to a grouping of applications governed by a common policy that shares access to authorization and authentication information on a given device, for a given user. Policy 420 can include the value of security variables used in authorization, authentication, and securitizing data on the device. For example, policy 420 can include password structure, how long the device can remain disconnected from the gateway, how many times the user can fail to enter in a correct password, and other security variables.

A further instance of a secure file partition is authentication store 425 which can contain authentication credentials (e.g., tokens and assertions), policy details, and a master encryption key used to encrypt all other secure file partitions' master files. An authentication store master file store can be encrypted with an ephemeral key generated based on a user password or phrase. Furthermore, authentication store 425 can be shared among multiple applications on the device to form a common store for enterprise access and sharing encrypted content.

Once application 415 and corresponding components are installed on mobile device 405, application 415 can request access to one or more internal services within an enterprise running on servers 430 or virtual machines 435 after passing one or more device security checks. The request from application 415 is first received at a perimeter gateway 440 where a first round of authentication is established before allowing application access to an intermediate layer 445. Intermediate layer 445 authenticates the user and ensures that the policy being enforced by application 415 is up-to-date. In addition, mobile device telemetry and configuration settings can be gathered, processed, analyzed, evaluated, and/or recorded within database 450. This information can be useful in creating (e.g., in real-time or in near real-time) various indicators of fraud or anomaly detection. Intermediate layer 445 also allows application 415 to log into mobile application store 450. In addition, proxy 455 can be used as an intermediary between application 415 and the servers 430.

FIG. 5 is a flowchart illustrating a set of exemplary operations 500 for authorizing an enterprise-managed application in accordance with some embodiments of the present invention. During receiving operation 510, a request from an enterprise-managed application can be received. The request can identify a named service within the enterprise to which the application would like to connect. Initiation operation 520 initiates a secure connection with a perimeter gateway. The perimeter gateway can then ensure the policy operating on the device is up-to-date using policy verification operation 530 and that the user is still authorized to access enterprise services during user verification operation 540.

If the policy and user are successfully validated, then validation operation 550 validates the user's authentication credentials at the gateway. Enterprise credentials are then passed to the destination service during submission operation 560 where authentication and authorization take place during verification operation 570. Upon successful authentication, binding operation 580 creates a binding between the application and the named service.

FIG. 6 is a flowchart illustrating a set of exemplary operations 600 for creating a secure channel between an enterprise service and an enterprise-managed application running on a remote device in accordance with one or more embodiments of the present invention. As illustrated in FIG. 6, the user causes an enterprise-managed application running on a client device to launch during launch operation 610. The application prompts the user for a set of container credentials. Once the credentials are received from the user, the client device uses encryption operation 620 to encrypt the data and communication with a server gateway of the enterprise.

The enterprise-managed application can use a framework authentication token (FAT) to authenticate with the gateway, and an enterprise authentication token (EAT) to authenticate with a service. Validation operation 630 determines (e.g., using a framework authentication system) the validity of the FAT. A server authorizer can then construct one or more tokens for creating a secure connection to the enterprise service. For example, in some embodiments the server authorizer can create a User Binding Token (UBT) consisting of the user id, the application id, and the device id. In addition, the FAT can be created by binding the UBT, EAT, and an expiration date. In addition, the server authorizer may determine if the user is authorized to access the enterprise. A secure mobile framework server can construct a policy based on the enterprise services the user can interact with. The information in the policy can include the FAT expiration date, a type of enterprise authentication the user must perform when the FAT expires, and other policy information used to secure data on the mobile device. The secure mobile framework server gateway can then respond to the mobile device with the FAT and the policy.

The calling client (e.g., the mobile device) can use an authentication store to save the FAT and policy content. The application can then use generation operation 640 to generate a connection request upon verification of the policy enforcement. Then creation operation 650 creates a secure channel between the enterprise-managed application and the enterprise service. For example, the application can ask the client secure mobile framework to connect to a particular enterprise service using some canonical name. Then, the framework can send the service name along with the UBT to the secure mobile framework server service authenticator over the same connection. The service authenticator determines if the UBT is allowed to connect to that destination.

The secure mobile framework server service router can then map the canonical name to the real address of the service, and establish a connection. The mobile application can now communicate freely over a secured channel once the enterprise authentication is successfully completed. On subsequent requests for connections, the application may ask the secure mobile framework to connect to a particular service using some canonical name. The secure mobile framework can then send the service name along with the UBT and EAT to the secure mobile framework gateway. In some embodiments, the next time the application attempts to connect with the service, this information can be used rather than the user entered enterprise credentials, at least until the FAT expires.

FIG. 7 is an example of an application built on a secure mobile framework which can be used with various embodiments of the present invention. As illustrated in FIG. 7, web browser 705 represents an implementation of a web browser capable of generating standard HTTP/S requests which may be wrapped in a custom protocol. Web browser 705 can use communications API 710 to establish a connection to the gateway. In some embodiments, communications API 710 can be built on top of secure socket layer (SSL) to access secure factory API 715 for authenticating the user. Typical web based applications require storage of data such as cookies shared with the server and historical URLs. The web browser implementation illustrated in FIG. 7 uses storage API 720 and a secure file partition manager to encrypt data before utilizing the operating system underlying file system 725

Communications API 710 obtains the user's raw credentials or stored token (FAT) to establish a connection with an enterprise gateway using secure key store 730. For example, upon receiving the user's credentials, a secure key can be retrieved from secure key store 730. This key can be used to access a key chain after which subcomponents of the framework can be initialized. System management 735 can receive, from the device/application, an identification of a current policy associated with the application. Using policy management 740 a determination can be made as to whether the policy associated with the application is up to date or needs to be updated. System management 735 can ensure that proper logging, virtual file system management, and page caching occur.

Upon successful authorization and authentication, the gateway requests policy and device information from communications API 710. Upon successful validation, the gateway can bind a connection to a web browser proxy service, capable of making HTTP/S calls within the enterprise. Web browser 705 can then transmit the wrapped HTTP/S requests through this channel.

FIG. 8 illustrates a remote device 805 accessing a server 810 within an enterprise in accordance with some embodiments of the present invention. As illustrated in FIG. 8, various embodiments of the present invention allow remote device 805 to access the enterprise through a multi-level authentication process. For example, in order to connect to an endpoint service running on server 810 within an enterprise, a container authentication, a framework authentication, and an enterprise authentication should all be successfully completed in some embodiments. Many traditional authentication systems would require that in order to use an application on a mobile device, a user typically enters a password to unlock the device and then supply a user name and password to authenticate against a remote service. In contrast, various embodiments of the present invention use multiple layers of security before allowing access to data on a device or connections to the remote services.

Upon launching application 815, a request is sent to far mobile content gateway 820. Within the main stack 825 of far mobile content gateway 820, validation and authentication of the user and device can be confirmed. For example, in some embodiments, an enterprise authentication service 830 (e.g., RSA® or Kerberos™) can be used. In some embodiments, the authentication process can include a username, a whitelist check, a policy check, and/or a destination check. In addition, device telemetry and configurations can be monitored and transmitted to a second intermediate authentication layer. These allow for the user, device, and application to be authenticated.

Once the user, device, and application have been authenticated, a connection can be established with server 810. Many embodiments use the various tokens created during the authentication of the user, device, and application for establishing a connection with server 810. Far mobile content gateway 820 can connect with mobile gateway services 835 for additional authentication services for access to servers within the enterprise. For example, in some embodiments, a user can enter a password or other authentication credentials within application 815 that can be used to decrypt data stored locally on the device. Then, the user could present a FAT to a gateway process running on a remote environment. The gateway process uses the FAT to authorize and authenticate the user and the device. Then, to access any particular service, the user would present an EAT to the remote service. In some embodiments, the FAT and EAT can be stored locally on the device after preforming one or more pluggable forms of authentication (e.g., time codes+pin, biometrics, passwords, etc.).

In some embodiments, the form of authentication can be rotated on a predefined schedule (e.g., periodic) or upon detection of one or more events. For example, the gateway can securely transmit the current authentication form to the mobile device which can be stored in the secure store. While FIG. 8 illustrates examples, such as HTTPS and TLS, of secure connections which can be used, other embodiments of the present invention can use different protocols for creating connections for messaging and transferring data between system components.

FIG. 9 is a sequence diagram illustrating an initial authentication flow between a device application and an enterprise in accordance with one or more embodiments of the present invention. As illustrated in FIG. 9, a user launches a device application. An integrity detection process is used to determine if the expected OS integrity is present. For example, the integrity detection process can determine if the device is operating in an elevated unauthorized privilege (e.g., rooting or jailbreak) mode. The device application requests a node identifier (e.g., a Kerberos™ ID) and an authentication password, at which point the device identifier is obtained from the device. An initial authentication request can then be submitted (e.g., using a secure connection) to the far content gateway. The initial authentication request can include the authentication password, the device identifier, application family, the device type, and/or other information. The far content gateway can then send an authentication request to an authentication service. Once authentication service authenticates the user, a UBT is registered by the mobile authorization service.

The mobile authorization service can authorize access, generate a UBT, and store the device identifier, the user name, application family, and the UBT. The mobile authorization service signs the UBT and authentication token before returning a policy, a UBT, and a digital signature to the far content gateway. The far content gateway then generates a FAT which is returned along with the policy, UBT and digital signature to the device application. In some cases, the policy may require the device application to request a new password for the secure container. The FAT, UBT, and digital signature can then be stored in the secure container which can be locked with the password.

FIG. 10 is a sequence diagram illustrating a continuous authentication flow between a device application and an enterprise in accordance with various embodiments of the present invention. In the embodiments illustrated in FIG. 10, a user launches a device application. An operating system integrity check (e.g., a jail break detection process) can then be used to determine if the integrity of the operating system has been compromised. If the operating system integrity check determines that the operating system is not as expected, then the application will not be allowed to connect with the gateway. If integrity of the operating system is as expected, the device application retrieves the secure container password from the user and unlocks the secure container to retrieve the current policy. The device application checks the enforcement of the policy and connects to the far content gateway. The far content gateway checks the digital signature of the UBT and the authentication token. The far content gateway can also check a directory to determine the status of the username and if the UBT is on a whitelist.

The device application submits the canonical name of the enterprise service to which the device application wants to connect. The far content gateway uses a destination service module to determine if the UBT is allowed to connect to that service. If the UBT is allowed to connect, the far content gateway binds a connection to the enterprise service, or a proxy to that service. A success code is returned from the far content gateway to the device application along with the latest policy version. The device application checks to see if the policy version just returned is greater than the policy retrieved from the secure container. If the policy version is greater, then the new policy is applied. The FAT can then be retrieved from the secure container and the conversation with the far content gateway can be initiated.

Various embodiments of the secure mobile framework utilize a number of paths which seek the balance between number of checks, types of checks, and actions taken. FIG. 11 illustrates a multi-stage key generation process based on multiple OS integrity checks in accordance with one or more embodiments of the present invention. In accordance with various embodiments, assembly code routines can be inserted at strategic points in the secure mobile framework code to test for known breaks in OS integrity. As illustrated in FIG. 11, stopping operation 1105 stops the debugger from attaching call. This forces binary modification to remove the key state from the keychain. Asynchronous check 1110 can pickup drive-by jailbreaks which happen after the application has been started.

Additional checks, such as filesystem checks 1115-1135 can also be used to test the ability to look outside the application's filesystem sandbox. For example, the filesystem checks 1115-1135 can test either the ability to access or open files/directories which should be inaccessible. The result of each of these checks can be combined with an application nonce as part of the ephemeral key generation 1140.

In accordance with various embodiments, there are several types of actions which can be taken as a result of finding the device has a compromised OS integrity. Actions can include visual actions, destructive actions, and/or an absence of a required operation. The visual action can pop up a dialog which indicates to users that the device does not pass the sufficient integrity requirements and that this violates compliance policy. The dialog may be shown for a period of time (e.g., for 5 seconds) before the application exits. The exit may be conducted on a background thread and cannot be easily hooked out through an objective-c message override. This action informs the user that the phone does not pass the sufficient integrity requirements, something they may not be aware of, and that this violates policy. It is expected to be found fairly quickly given its obvious nature, however, it may only be reached after passing through a more destructive check first.

The destructive action calls on a clear method, may be used as part of normal container operation, which removes all container material in the keychain. Once removed, the user is left in the initial provision state and needs to go through the provision process again which requires authentication. The final action effectively does not happen. There are a number of components thrown into the ephemeral container key generation including device reference, salt, password and an application nonce.

FIG. 12 illustrates an example of an ephemeral key generation in accordance with some embodiments of the present invention. In accordance with one or more embodiments, an application nonce can be retrieved and a number of checks (Silent 2 & 3 as illustrated in FIG. 11) may be run as part of the normal container login process. Each of the checks may be combined (e.g., XOR) with this nonce key in a particular way. Thus, the generation of the ephemeral container key is dependent on the modified key and equally if the key is not modified then the key will be incorrectly generated and will fail to decrypt properly. If the check fails because the device has a compromised operating system, then the nonce will not be modified. Furthermore, as debugging is happening on a compromised device, the original nonce key loaded and held in memory, assuming the hacker knows that the nonce is a component to the key generation will be left untouched and is less likely to raise suspicion of being the problem.

FIG. 13 illustrates an application integrity check in accordance with various embodiments of the present invention. The application integrity check, in accordance with some embodiments, can be based on calculating a hash of some or all of the read only portions of the binary. As illustrated in FIG. 13, some embodiments can use an application nonce (e.g., a 20 byte nonce). The nonce may be sent from the server and used to XOR with the calculated hash to produce a modified nonce. The modified nonce can then be sent back to the server. The modified nonce can be XOR'd with the original nonce to reveal the calculated hash. This calculated hash can be checked against a set of know pre-computed hash signatures. The pre-computed has signature for an application can be calculated prior to application distribution. Based on this check, a determination can be made as to whether the binary has been modified in some way and is invalid. If there is a difference the application can be denied access to requested services and/or be given a modified policy which can be enacted on the device.

### Exemplary Computer System Overview

Embodiments of the present invention include various steps and operations, which have been described above. A variety of these steps and operations may be performed by hardware components which are part of a mobile device, server, or other computer system used within embodiments of the present invention. In some embodiments, these steps and operations may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 14 illustrates some components which may be used as part of a computer system 1400 with which embodiments of the present invention may be utilized. As illustrated in FIG. 14, the computer system may include a bus 1410, at least one processor 1420, at least one communication port 1430, a main memory 1440, a removable storage media 1450, a read only memory 1460, and a mass storage 1470. In some cases, computer system 1400 may not include any local storage such as removable storage media 1450, mass storage 1470, and the like.

Processor(s) 1420 can be any known processor, such as, but not limited to, an Intel® Itanium® or Itanium 2® processor(s); AMD® Opteron® or Athlon MP® processor(s); ARM-based processors; or Motorola® lines of processors. Communication port(s) 1430 can be any of an RS-232 port for use with a modem-based dialup connection, a 10/100 Ethernet port, or a Gigabit port using copper or fiber. Communication port(s) 1430 may be chosen depending on a network such as a Local Area Network (LAN), Wide Area Network (WAN), or any network to which the computer system 1400 connects.

Main memory 1440 can be Random Access Memory (RAM) or any other dynamic storage device(s) commonly known in the art. Read only memory 1460 can be any static storage device(s) such as Programmable Read Only Memory (PROM) chips for storing static information such as instructions for processor 1420.

Mass storage 1470 can be used to store information and instructions. For example, hard disks such as the Adaptec® family of SCSI drives, an optical disc, an array of disks such as RAID, such as the Adaptec family of RAID drives, or any other mass storage devices may be used.

Bus 1410 communicatively couples processor(s) 1420 with the other memory, storage, and communication blocks. Bus 1410 can be a PCI/PCI-X or SCSI based system bus depending on the storage devices used.

Removable storage media 1450 can be any kind of external hard-drives, floppy drives, IOMEGA® Zip Drives, Compact Disc—Read Only Memory (CD-ROM), Compact Disc—Re-Writable (CD-RW), and/or Digital Video Disk—Read Only Memory (DVD-ROM).

The components described above are meant to exemplify some types of possibilities. In no way should the aforementioned examples limit the scope of the invention, as they are only exemplary embodiments. Moreover, some of the computer systems (e.g., servers, clients, mobile devices, etc.) contemplated by embodiments of the present invention may not include all of these components. In addition, some of the computer systems may include different configurations and/or additional components from those illustrated in FIG. 14. For example, some computer systems (e.g., mobile devices) may include a GPS unit and various types of I/O devices (e.g., touchscreens, eye tracking modules, natural language processors, LCD, keyboards, etc.).

In conclusion, the present invention provides novel systems, methods and arrangements for a secure mobile framework for enterprise-managed applications. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features.

What is claimed is:

1. A method comprising:
receiving, at a remote device, a request to access to a secure container within a memory of the remote device, wherein the secure container is encrypted using information about an operating system of the remote device in an unaltered state;
determining a current state of the operating system of the remote device;
generating, using a processor, a decryption key based on the current state of the operating system of the remote device; and
allowing the secure container to be accessed when the decryption key successfully decrypts the secure container.

2. The method of claim 1, wherein generating the decryption key includes a multi-stage key generation sequence based on the current state of the operating system of the remote device.

3. The method of claim 2, wherein the multi-stage key generation sequence is also based on a user password, a device identification, or an application nonce.

4. The method of claim 1, further comprising transmitting the current state of the operating system to a remote gateway.

5. The method of claim 1, further comprising receiving a gateway generated token at the remote device, wherein the decryption key is also generated based on the token.

6. The method of claim 1, further comprising receiving a password from a user of the remote device, wherein the password is used in generating the decryption key.

7. The method of claim 1, further comprising removing data from the secure container when the decryption key does not successfully decrypt the secure container.

8. The method of claim 1, further comprising asynchronously checking the current state of the operating system while generating the decryption key in order to determine if the current state of the operating system has changed.

9. The method of claim 1, wherein determining the current state of the operating system of the remote device is a multi-level determination that includes checking at least a filesystem check, a virtual memory check, or a binary check.

10. A method comprising:
receiving, at a remote device, a request to access a secure container within a memory of the remote device, wherein the secure container is accessible using an access key;
generating a key to access the secure container by performing a multi-stage key generation sequence based, at least in part, on current configurations of the remote device;
determining if the key generated by the multi-stage key generate sequence matches the access key; and
allowing access to the secure container within the memory of the remote device when the access key matches the key generated by the multi-stage key generations sequence.

11. The method of claim 10, wherein the key is modified at each stage in the multi-stage key generation sequence if the current configurations of the remote device indicate that there has been no modification of a portion of the remote device.

12. The method of claim 10, wherein the key is not modified at a stage in the multi-stage key generation sequence if the current configurations of the remote device indicate that there has been a modification to a portion of the remote device.

13. The method of claim 10, wherein the multi-stage key generation sequence includes a file system check, a virtual memory check, or a binary check.

14. The method of claim 10, wherein generating the key is dependent on successful validation of a user credential and a successful operating system integrity check.

15. The method of claim 10, wherein the multi-stage key generation sequence includes:
loading an application nonce;
determining whether a filesystem integrity has been compromised; and
determining whether a virtual memory page integrity has been compromised.

16. The method of claim 15, wherein the application nonce is a cryptographic nonce that is randomly generated.

17. The method of claim 10, wherein the multi-stage key generation sequence includes performing multiple operating system integrity checks to determine if an expected operating system integrity is present.

18. The method of claim 10, wherein the secure container has data stored therein related to a service accessible through a remote gateway.

19. The method of claim 18, wherein the service includes an e-mail service, a trading service, a payment processing service, a customer relationship management service, an inventory system service, a business intelligence service, a healthcare service, a student information service, or a reservation service.

20. The method of claim 10, wherein the secure container includes a framework authentication token used to access the remote gateway.

21. A remote device comprising:
a processor;
a memory having stored thereon an operating system to manage resources of the remote device;
a secure container stored within the memory of the remote device, wherein the secure container is accessible using an access key;
a validator to test operating system integrity at multiple points;
a key generator configured to generate a key to access the secure container by performing a multi-stage key generation sequence based on the operating system integrity determined by the validator;
an access module to determine if the key generated by the multi-stage key generate sequence matches the access key and allow access to the secure container within the memory of the remote device when the access key matches the key generated by the multi-stage key generations sequence.

22. The system of claim 21, further comprising a data removal module to remove data stored in the secure container when the validator determines that the operating system integrity has been compromised.

23. A method comprising:
performing multi-point operating system integrity check on a remote device;
generating an authentication token based on the multi-point operating system integrity check;
initiating a service connection request to establish a secure connection between the remote device and a gateway based on the authentication token; and
creating the secure connection between an enterprise service and the remote device upon successful validation of the service connection request.

24. The method of claim 23, wherein any data transmitted to the remote device is stored within a secure container only accessible by an enterprise-managed application.

25. The method of claim 24, wherein the secure container is encrypted using information about an uncompromised operating system of the remote device.

26. The method of claim 23, further comprising determining a policy that the initiating device should enact in managing an enterprise-managed application.

27. The method of claim 23, wherein the secure connection will not be created if the enterprise cannot verify validation token.
